(19) United States
(12) Patent Application Publication
(10) Pub. No.: US 2026/0133414 A1
(43) Pub. Date: May 14, 2026

(54) OPTICAL PATH SWITCHER AND IMAGE CAPTURE DEVICE

(71) Applicant: Luxvisions Innovation Technology Corp. Limited, Guangzhou City (CN)

(72) Inventors: Cheng-Te Tseng, Guangzhou City (CN); Shu-Hung Liu, Guangzhou City (CN)

(73) Assignee: Luxvisions Innovation Technology Corp. Limited, Guangzhou City (CN)

(21) Appl. No.: 19/384,676

(22) Filed: Nov. 10, 2025

(30) Foreign Application Priority Data
Nov. 13, 2024 (CN) 202411623332.5

(51) Int. Cl. G02B 26/08; G03B 5/00; G03B 13/34

(52) U.S. Cl. CPC G02B 26/0816; G03B 5/00; G03B 13/34

(57) ABSTRACT

An optical path switcher includes a first lens having a first focal length, a second lens adjacent to the first lens and having a second focal length different from the first focal length, a fixed mirror assembly located downstream of the first lens in an optical path corresponding to the first lens and including a first reflective surface, a movable mirror assembly located downstream of the second lens in an optical path corresponding to the second lens or downstream of the first reflective surface in an optical path corresponding to the first reflective surface and including a second reflective surface, and a rotation module including a first rotation module connected to the movable mirror assembly and driving the movable mirror assembly to rotate to cause the second reflective surface to be located downstream of the second lens or the first reflective surface. An image capture device is also provided

### CROSS-REFERENCE TO RELATED APPLICATION

This non-provisional application claims priority under 35 U.S.C. § 119(a) to Patent Application No. 202411623332.5 filed in China on November 13, 2024, the entire contents of which are hereby incorporated by reference.

### BACKGROUND

### TECHNICAL FIELD

The present invention relates to an optical path switcher, and in particular to an optical path switcher used in an image capture device.

### RELATED ART

With the development of photography technology, photography is no longer just a photography tool for users but has also been integrated into everyday life as an important medium for recording and sharing events. A single-lens reflex camera known to the inventor no longer meets requirements of users in terms of convenience in use. For example, users of single-lens reflex cameras need to carry a plurality of lenses of different focal length ranges or filter effects to satisfy various photography requirements in different scenarios.

With the enhancement of photography functions of electronic devices such as mobile phones and tablets, requirements of users for a camera equipped in the electronic devices gradually increase. For example, users want to be able to carry electronic devices to photograph plants or insects with macro photography, photograph landscapes and buildings with a wide-angle lens, or photograph distant objects and animals with a telephoto lens. However, due to the limitations on the sizes of electronic devices, it is difficult to achieve a wide range of focal lengths.

### SUMMARY

In view of this, the present invention provides an optical path switcher, including a first lens, a second lens, a fixed mirror assembly, a movable mirror assembly, and a rotation module. The first lens has a first focal length. The second lens is adjacent to the first lens, the second lens has a second focal length, and the second focal length is different from the first focal length. The fixed mirror assembly is located downstream of the first lens in an optical path corresponding to the first lens, and the fixed mirror assembly includes a first reflective surface. The movable mirror assembly is located downstream of the second lens in an optical path corresponding to the second lens or downstream of the first reflective surface in an optical path corresponding to the first reflective surface, and the movable mirror assembly includes a second reflective surface. The rotation module includes a first rotation module connected to the movable mirror assembly, and the first rotation module drives the movable mirror assembly to rotate to cause the second reflective surface to be located downstream of the second lens in the optical path corresponding to the second lens or downstream of the first reflective surface in the optical path corresponding to the first reflective surface.

In an embodiment, when the second reflective surface faces the second lens, an imaging light passes through the second lens and is reflected by the second reflective surface.

In an embodiment, when the second reflective surface faces the first reflective surface, an imaging light passes through the first lens and is reflected sequentially by the first reflective surface and the second reflective surface.

In an embodiment, a relay mirror assembly is included. The relay mirror assembly includes a third reflective surface, and the third reflective surface is located between the first reflective surface and the movable mirror assembly, to reflect the imaging light reflected by the first reflective surface to the second reflective surface.

In an embodiment, a plurality of first lenses are provided, a plurality of fixed mirror assemblies are provided, the rotation module includes a second rotation module connected to the relay mirror assembly, and the second rotation module drives the relay mirror assembly to rotate to cause the third reflective surface to be located downstream of the first reflective surface of one of the fixed mirror assemblies and upstream of the movable mirror assembly in an optical path corresponding to the fixed mirror assembly and the movable mirror assembly.

In an embodiment, the movable mirror assembly includes a light shielding surface located on a back surface of the second reflective surface, and the light shielding surface does not allow a light to penetrate.

In an embodiment, the first lens and the second lens each have an incident optical axis, the incident optical axes are parallel to each other, and an imaging light enters the first lens and the second lens along the incident optical axes.

In an embodiment, a plurality of first lenses are provided, each of the first lenses has an incident surface, and the incident surfaces face different directions.

The present invention additionally provides an image capture device, including the foregoing optical path switcher and a photosensitive module. The photosensitive module is located downstream of the second reflective surface of the movable mirror assembly in an optical path corresponding to the movable mirror assembly.

In an embodiment, the image capture device includes a focus lens and an actuator, where the actuator actuates the focus lens to move between the movable mirror assembly and the photosensitive module.

The following describes the present invention in detail with reference to accompanying drawings and specific embodiments but should not be used as a limitation on the present invention.

### BRIEF DESCRIPTION OF THE DRAWINGS

FIG. 1 is a three-dimensional view of an image capture device according to an embodiment, showing that an imaging light enters from a second lens;

FIG. 2 is a three-dimensional view of an image capture device according to another embodiment, showing that an imaging light enters from a first lens;

FIG. 3 is a schematic three-dimensional view of an image capture device according to another embodiment;

FIG. 4 is a three-dimensional view of the image capture device according to the embodiment in FIG. 3 from another angle;

FIG. 5 is a three-dimensional view of the image capture device according to the embodiment in FIG. 3 from yet another angle;

FIG. 6 is a three-dimensional view of the image capture device according to the embodiment in FIG. 3 from yet another angle, showing that an imaging light enters from a second lens;

FIG. 7 is a three-dimensional view of an image capture device according to another embodiment, showing that an imaging light enters from a second lens;

FIG. 8 is a three-dimensional view of the image capture device according to the embodiment in FIG. 6, showing that an imaging light enters from a first lens;

FIG. 9 is a three-dimensional view of the image capture device according to the embodiment in FIG. 6, showing that an imaging light enters from a first lens;

FIG. 10 is a three-dimensional view of the image capture device according to the embodiment in FIG. 7, showing that an imaging light enters from a first lens;

FIG. 11 is a three-dimensional view of the image capture device according to the embodiment in FIG. 7, showing that an imaging light enters from a first lens;

FIG. 12 is a three-dimensional view of an image capture device according to yet another embodiment;

FIG. 13 is a three-dimensional view of an image capture device according to yet another embodiment;

FIG. 14 is a three-dimensional view of an image capture device according to yet another embodiment;

FIG. 15 is a three-dimensional view of an image capture device according to yet another embodiment;

FIG. 16 is an optical path diagram of entering the image capture device from a first lens according to the embodiment in FIG. 15;

FIG. 17 is an optical path diagram of entering the image capture device from a first lens according to the embodiment in FIG. 15;

FIG. 18 is an optical path diagram of entering the image capture device from a first lens according to the embodiment in FIG. 15;

FIG. 19 is an optical path diagram of entering the image capture device from a first lens according to the embodiment in FIG. 15;

FIG. 20 is an optical path diagram of entering the image capture device from a first lens according to the embodiment in FIG. 15;

FIG. 21 is an optical path diagram of entering the image capture device from a first lens according to the embodiment in FIG. 15;

FIG. 22 is a three-dimensional view of an image capture device according to yet another embodiment;

FIG. 23 is an exploded view of elements of the image capture device according to the embodiment in FIG. 6;

FIG. 24 is a schematic diagram of an electronic device according to an embodiment; and

FIG. 25 is a perspective view of the embodiment in FIG. 24.

### DETAILED DESCRIPTION

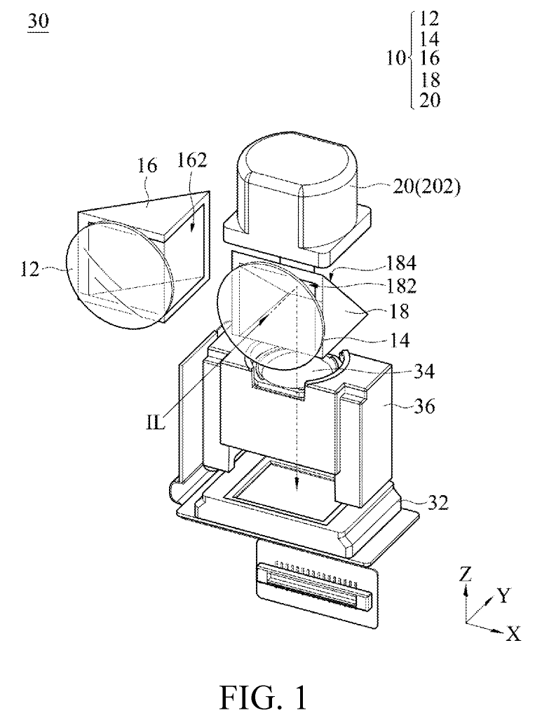

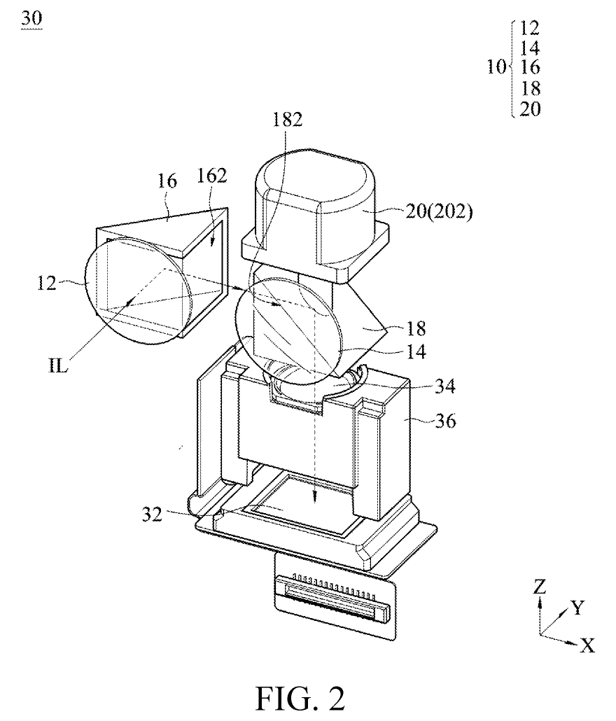

Referring to FIG. 1 and FIG. 2, FIG. 1 is a three-dimensional view of an image capture device according to an embodiment, showing that an imaging light enters from a second lens, and FIG. 2 is a three-dimensional view of an image capture device according to another embodiment, showing that an imaging light enters from a first lens. An optical path switcher 10 includes a first lens 12, a second lens 14, a fixed mirror assembly 16, a movable mirror assembly 18, and a rotation module 20. The first lens 12 has a first focal length, the second lens 14 is adjacent to the first lens 12 and has a second focal length, and values of the first focal length and the second focal length are different. The fixed mirror assembly 16 is located downstream of the first lens 12 in an optical path corresponding to the first lens 12 and includes a first reflective surface 162. The movable mirror assembly 18 is located downstream of the second lens 14 in an optical path corresponding to the second lens 14 or downstream of the first reflective surface 162 in an optical path corresponding to the first reflective surface 162, and the movable mirror assembly 18 includes a second reflective surface 182. The first reflective surface 162 and the second reflective surface 182 can reflect a light.

The rotation module 20 includes a first rotation module 202. The first rotation module 202 is connected to the movable mirror assembly 18. The first rotation module 202 may rotate, and drive, during rotation, the movable mirror assembly 18 to rotate together, so that the second reflective surface 182 in the movable mirror assembly 18 may be located downstream of the second lens 14 in the optical path corresponding to the second lens 14 or downstream of the first reflective surface 162 in the optical path corresponding to the first reflective surface 162, to reflect a light entering from the second lens 14 or a light that enters from the first lens 12 and is reflected by the first reflective surface 162.

Still referring to FIG. 1 and FIG. 2, the optical path switcher 10 may be integrated with a photosensitive module 32 to form an image capture device 30. The photosensitive module 32 is located downstream of the second reflective surface 182 of the movable mirror assembly 18 in an optical path corresponding to the movable mirror assembly 18, to capture an imaging light IL of a target object in an environment. When an image of the target object in the environment is to be captured, the imaging light IL of the target object may enter the image capture device 30 from the first lens 12 or the second lens 14, and is reflected by the optical path switcher 10, allowing the photosensitive module 32 to receive the imaging light IL of the target object, and convert the imaging light IL into the image of the target object.

In some embodiments, the first focal length of the first lens 12 is different from the second focal length of the second lens 14, aiming to provide the image capture device 30 with an imaging function with a plurality of focal length ranges, to satisfy different photography requirements. For example, the first focal length of the first lens 12 may range between 35 millimeters and 60 millimeters, making the first lens 12 a standard lens suitable for general everyday photography of portraits and landscapes. The second focal length of the second lens 14 is different from the first focal length. For example, the second focal length is less than 35 millimeters, making the second lens 14 a short-focus lens suitable for wide-angle photography.

Specific values of the focal lengths of the first lens 12 and the second lens 14 are not limited herein. In addition to the standard lens and the short-focus lens exemplified above, the first lens 12 and the second lens 14 may alternatively be, depending on the size of the focal length, an ultra-wide-angle lens (with a focal length less than 24 millimeters), a medium telephoto lens (with a focal length between 40 millimeters and 70 millimeters), a telephoto lens (with a focal length greater than 135 millimeters), or a super-telephoto lens (with a focal length greater than or equal to 400 millimeters).

The optical path switcher 10 in the image capture device 30 may enable the image capture device 30 to switch between lenses with different focal lengths in a case that only one photosensitive module 32 is provided. This allows the imaging lights IL entering the image capture device 30 from the lenses with different focal lengths to all enter the same photosensitive module 32 through optical path switching of the optical path switcher 10.

An example in which the first lens 12 is suitable for general everyday photography and the second lens 14 is suitable for wide-angle photography is used here. When a user wants to perform everyday photography, the first rotation module 202 of the optical path switcher 10 drives the movable mirror assembly 18 to rotate to cause the second reflective surface 182 of the movable mirror assembly 18 to be located downstream of the first reflective surface 162 in an optical path corresponding to the first reflective surface 162. When the imaging light IL enters the image capture device 30 from the first lens 12, the imaging light IL passing through the first lens 12 is reflected by the first reflective surface 162 of the fixed mirror assembly 16 to the second reflective surface 182 of the movable mirror assembly 18, and is then reflected by the second reflective surface 182 to the photosensitive module 32 (as shown in FIG. 2). When the user wants to perform wide-angle photography, the first rotation module 202 of the optical path switcher 10 drives the movable mirror assembly 18 to rotate to cause the second reflective surface 182 of the movable mirror assembly 18 to be located downstream of the second lens 14 in an optical path corresponding to the second lens 14. When the imaging light IL enters the image capture device 30 from the second lens 14, the imaging light IL passing through the second lens 14 reaches the second reflective surface 182 of the movable mirror assembly 18 and is then reflected by the second reflective surface 182 to the photosensitive module 32 (as shown in FIG. 1). In this way, through the change of the position of the second reflective surface 182 of the movable mirror assembly 18 through the optical path switcher 10, the imaging light IL entering the image capture device 30 from either the first lens 12 or the second lens 14 can reach the photosensitive module 32.

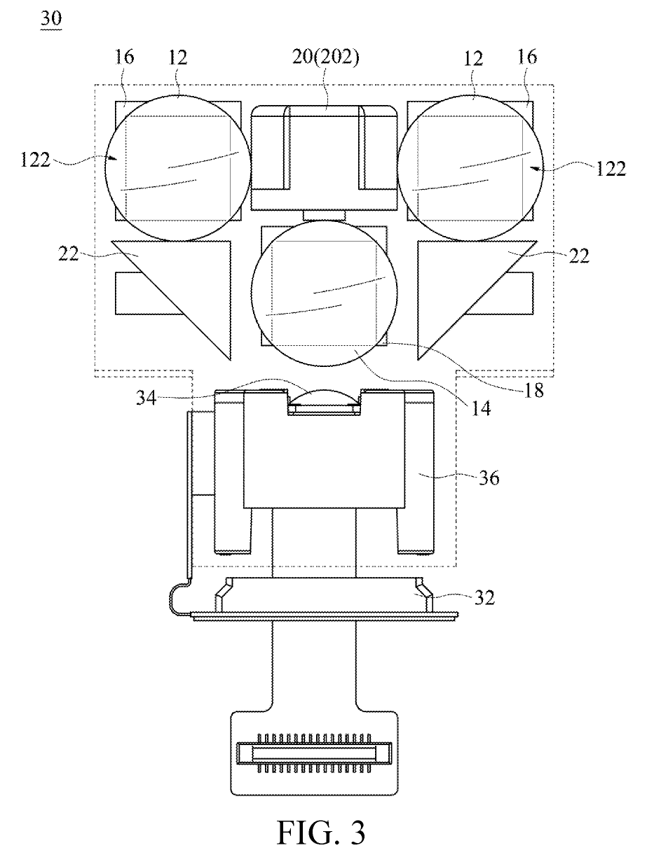

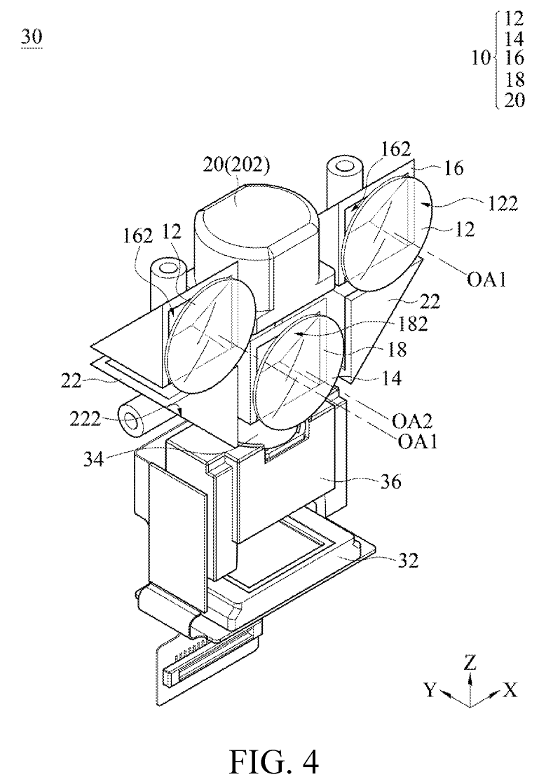

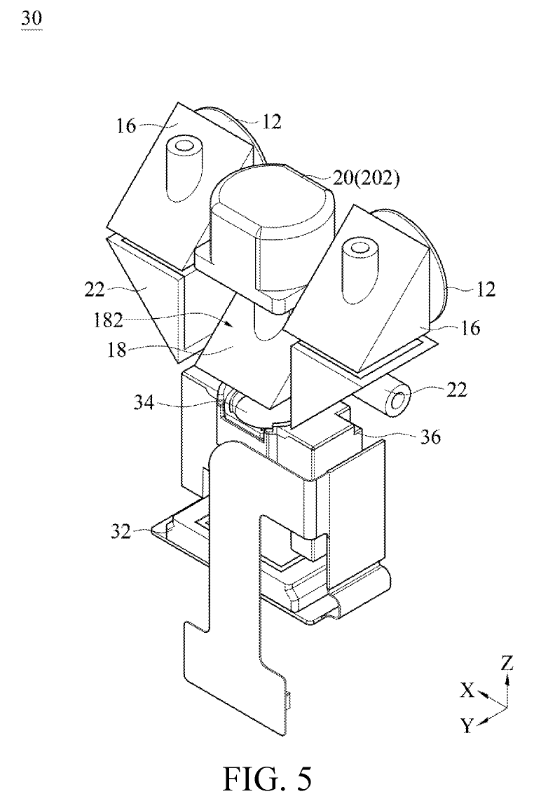

Referring to FIG. 3 to FIG. 5, FIG. 3 is a schematic three-dimensional view of an image capture device according to another embodiment, FIG. 4 is a three-dimensional view of the image capture device according to the embodiment in FIG. 3 from another angle, and FIG. 5 is a three-dimensional view of the image capture device according to the embodiment in FIG. 3 from yet another angle. In some embodiments, a relay mirror assembly 22 may be arranged between a fixed mirror assembly 16 and a movable mirror assembly 18 of an optical path switcher 10, so that all lights entering from first lenses 12 located at different positions can reach a second reflective surface 182 of the movable mirror assembly 18, and in an embodiment in which the optical path switcher 10 is integrated into an image capture device 30, all the lights entering from the first lenses 12 located at different positions can enter a same photosensitive module 32.

In some embodiments, the relay mirror assembly 22 includes a third reflective surface 222. The third reflective surface 222 is located between a first reflective surface 162 of the fixed mirror assembly 16 and the movable mirror assembly 18, to reflect an imaging light IL reflected by the first reflective surface 162 of the fixed mirror assembly 16 to the second reflective surface 182. In some embodiments, referring to FIG. 1 and FIG. 3 separately, it may be seen that an adjacency between the first lens 12 and the second lens 14 is not limited. Only when the first lens 12 and the second lens 14 are arranged as shown in FIG. 3, the relay mirror assembly 22 can be added to enable the light entering from the first lens 12 to be reflected by the movable mirror assembly 18.

In some embodiments, a plurality of first lenses 12 are provided, and each of the first lenses 12 is adjacent to the second lens 14. A quantity of fixed mirror assemblies 16 corresponds to a quantity of first lenses 12, and first reflective surfaces 162 of the fixed mirror assemblies 16 are respectively located downstream of the first lenses 12 in optical paths corresponding to the first lenses 12. In this case, a plurality of relay mirror assemblies 22 may be provided, and each of the relay mirror assemblies 22 are respectively located between the fixed mirror assemblies 16 and the movable mirror assembly 18. In some embodiments, first focal lengths of the first lenses 12 may also vary, allowing the imaging lights IL entering from the different first lenses 12 to also achieve different photography effects.

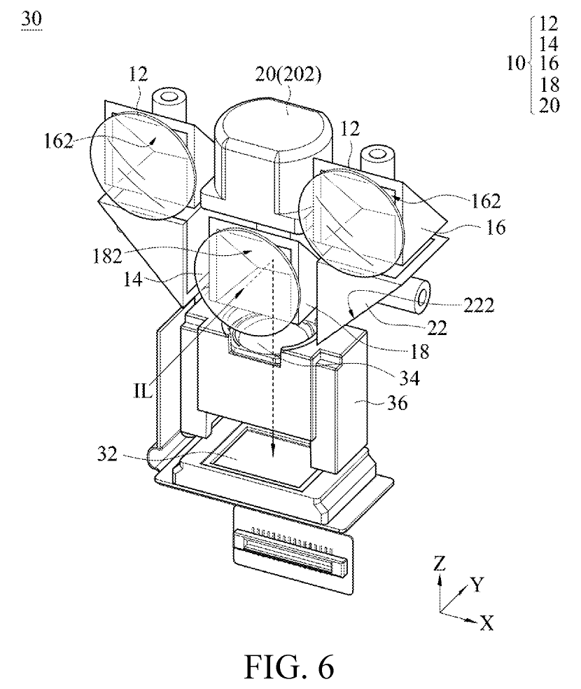

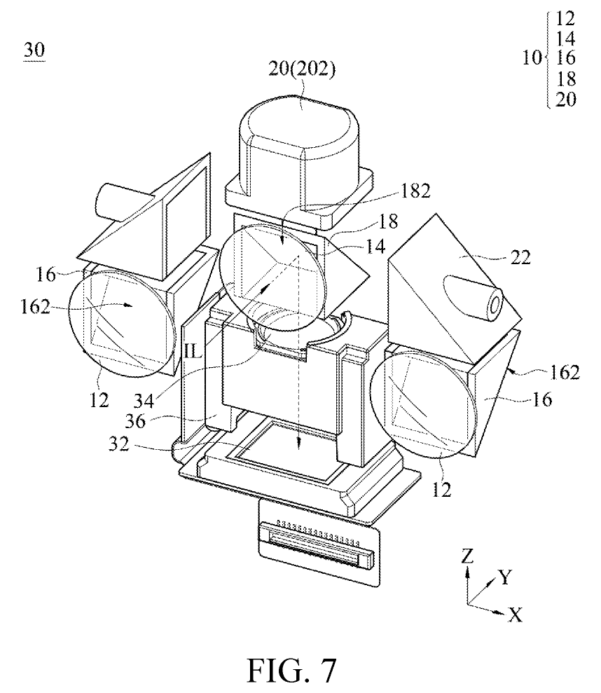

Referring to FIG. 6 and FIG. 7, FIG. 6 is a three-dimensional view of the image capture device according to the embodiment in FIG. 3 from yet another angle, showing that an imaging light enters from the second lens, and FIG. 7 is a three-dimensional view of an image capture device according to another embodiment, showing that an imaging light IL enters from a second lens. In the embodiment in which the optical path switcher 10 includes the relay mirror assemblies 22, when the imaging light enters the optical path switcher 10 from the second lens 14, the imaging light IL travels along the second reflective surface 182 and is reflected.

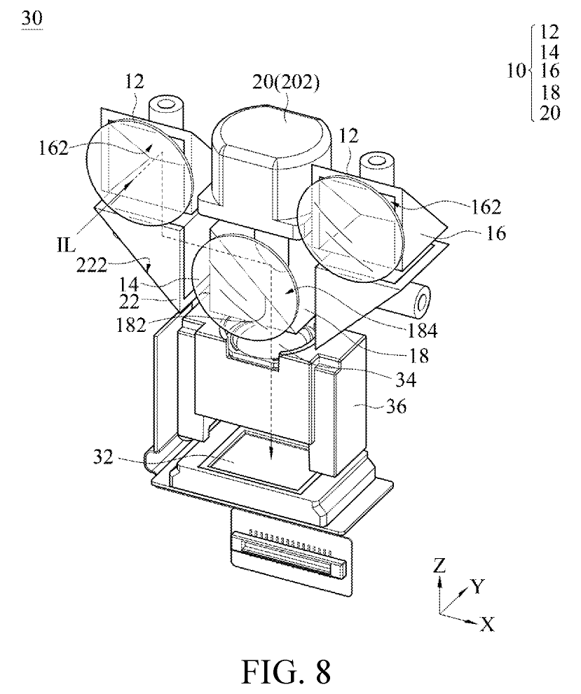

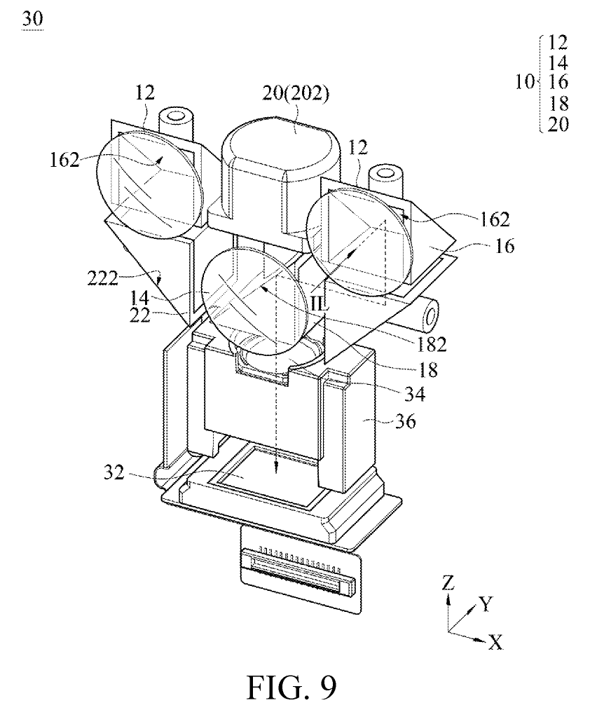

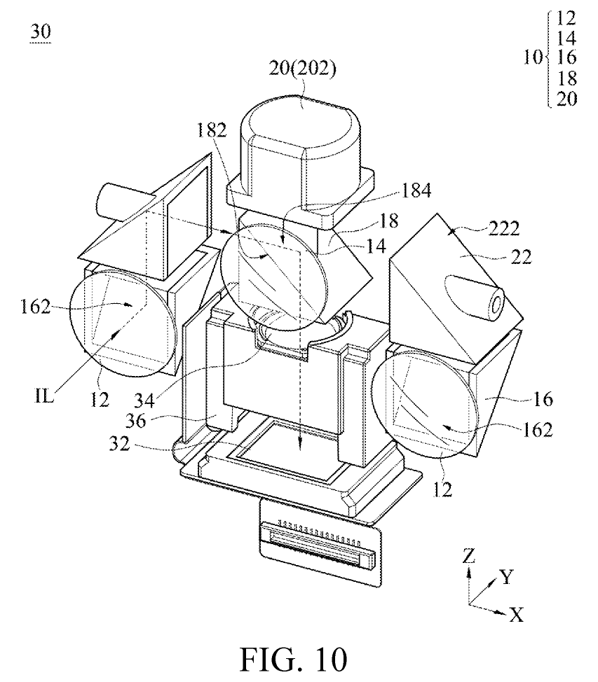

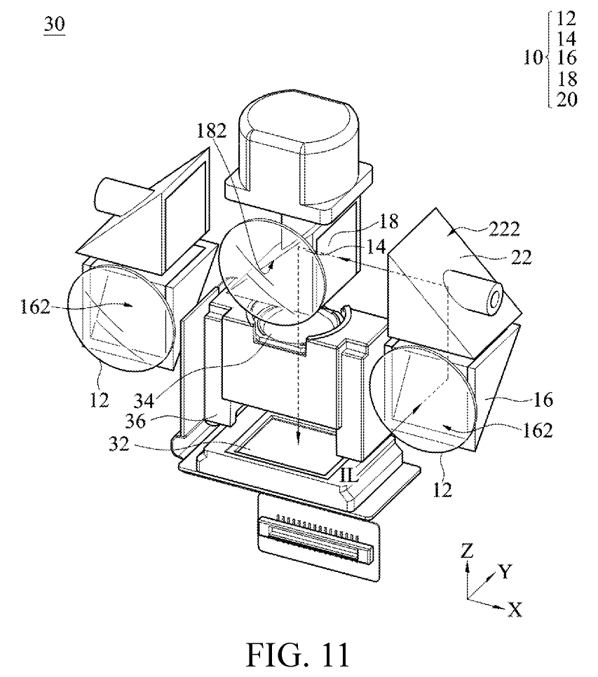

Referring to FIG. 8, FIG. 9, FIG. 10, or FIG. 11, FIG. 8 and FIG. 9 are three-dimensional views of the image capture device according to the embodiment in FIG. 6, showing that an imaging light enters from a first lens, and FIG. 10 and FIG. 11 are three-dimensional views of the image capture device according to the embodiment in FIG. 7, showing that an imaging light enters from a first lens. In these embodiments, the first lenses 12 and the second lens 14 may be arranged in a staggered manner. Specifically, the fixed mirror assemblies 16 may be located at two sides of a first rotation module 202, or the fixed mirror assemblies 16 may be arranged on a side close to the photosensitive module 32. Only when the relay mirror assembly 22 is located between the fixed mirror assembly 16 and the movable mirror assembly 18 to cause the third reflective surface 222 to face both the fixed mirror assembly 16 and the movable mirror assembly 18, a light from the fixed mirror assembly 16 may be reflected to the movable mirror assembly 18. When the imaging light IL enters the optical path switcher 10 from the first lens 12, the first rotation module 202 rotates to drive the movable mirror assembly 18 to rotate accordingly, to cause the second reflective surface 182 of the movable mirror assembly 18 to be located downstream of the third reflective surface 222 of the relay mirror assembly 22 in an optical path corresponding to the relay mirror assembly 22. The imaging light IL is sequentially reflected by the first reflective surface 162 of the fixed mirror assembly 16, the third reflective surface 222 of the relay mirror assembly 22, and the second reflective surface 182 of the movable mirror assembly 18.

Still referring to FIG. 8, the movable mirror assembly 18 includes a light shielding surface 184. The light shielding surface 184 is located on a back surface of the second reflective surface 182, and the light shielding surface 184 does not allow a light to penetrate. In the embodiment in which a plurality of first lenses 12 are provided, the first lenses 12 may include a first lens 12a and a first lens 12b. When the user uses the first lens 12a for photographing, and the second reflective surface 182 of the movable mirror assembly 18 faces the relay mirror assembly 22 corresponding to the first lens 12a to be located downstream of the relay mirror assembly 22 in an optical path corresponding to the relay mirror assembly 22, the light shielding surface 184 may shield an imaging light entering from the first lens 12b. This reduces interference caused by the imaging light IL entering the optical path switcher 10 from the first lens 12b on the image formed by the photosensitive module 32.

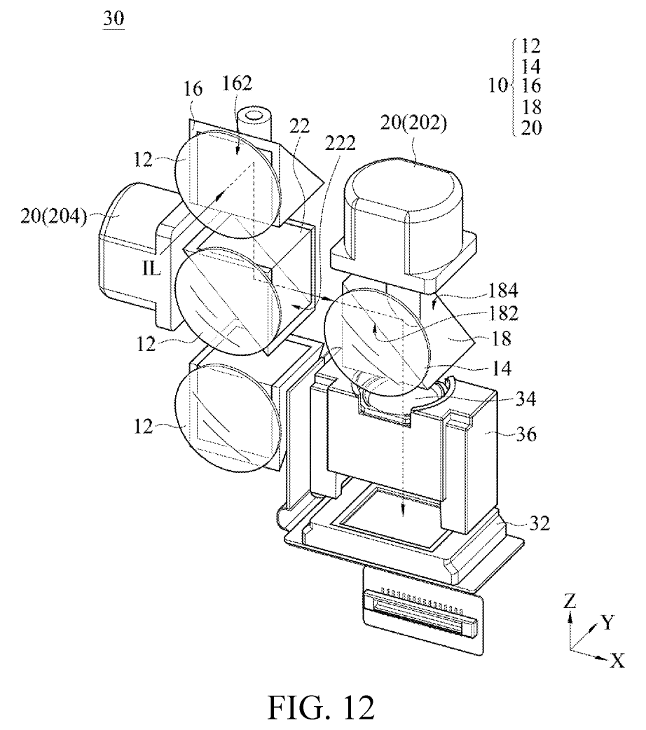

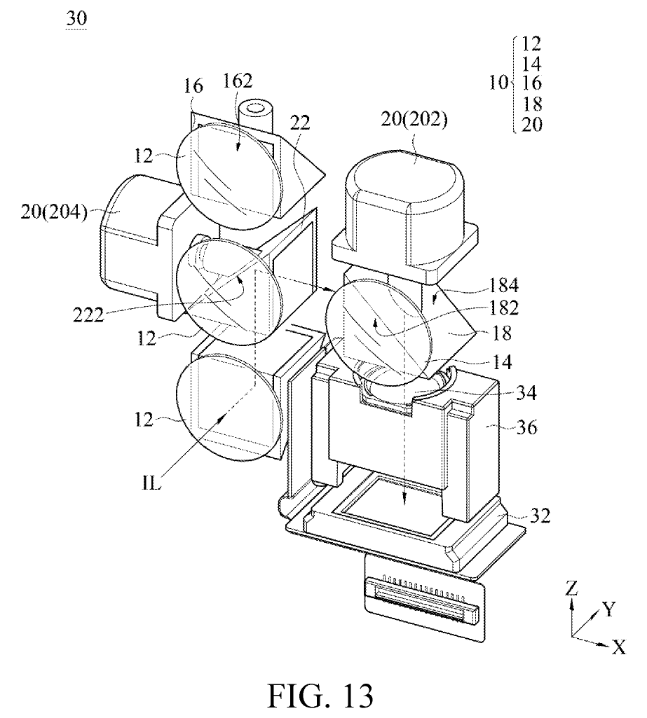

Referring to FIG. 12 and FIG. 13, FIG. 12 and FIG. 13 are three-dimensional views of an image capture device according to yet another embodiment. In some embodiments, a rotation module 20 includes a second rotation module 204. The second rotation module 204 is connected to a relay mirror assembly 22. When rotating, the second rotation module 204 may drive the relay mirror assembly 22 to rotate to cause a third reflective surface 222 of the relay mirror assembly 22 to be located downstream of a first reflective surface 162 of a fixed mirror assembly 16 and upstream of a movable mirror assembly 18 in an optical path corresponding to the fixed mirror assembly 16 and the movable mirror assembly 18. In this embodiment, a plurality of first lenses 12 and a plurality of fixed mirror assemblies 16 are provided, and one first lens 12 corresponds to one fixed mirror assembly 16 or one relay mirror assembly 22, where one relay mirror assembly 22 may be arranged between every two fixed mirror assemblies 16. The second rotation module 204 rotates, to drive the relay mirror assembly 22 to rotate to cause the third reflective surface 222 of the relay mirror assembly 22 to face a first reflective surface 162 of one of the two fixed mirror assemblies 16, to reflect an imaging light IL reflected from the first reflective surface 162 to a second reflective surface 182 of the movable mirror assembly 18.

It may be seen from FIG. 12 and FIG. 13 that the third reflective surface 222 of the relay mirror assembly 22 faces one fixed mirror assembly 16 to reflect an imaging light reflected from the fixed mirror assembly 16 to the movable mirror assembly 18.

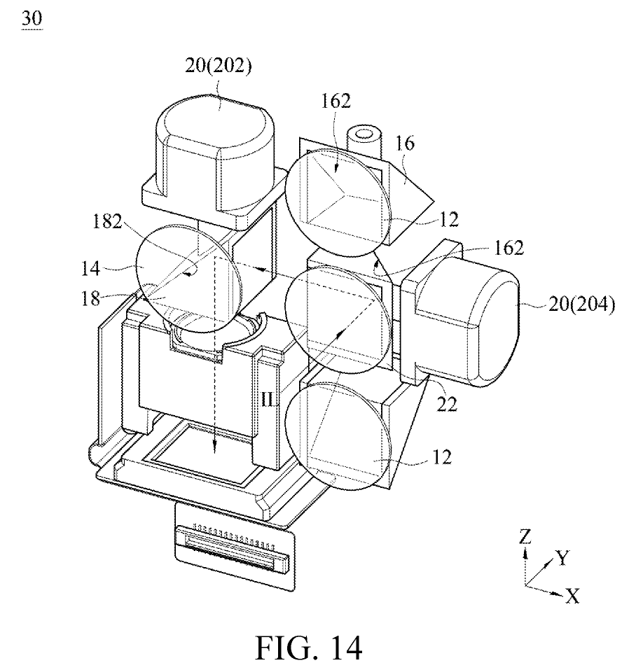

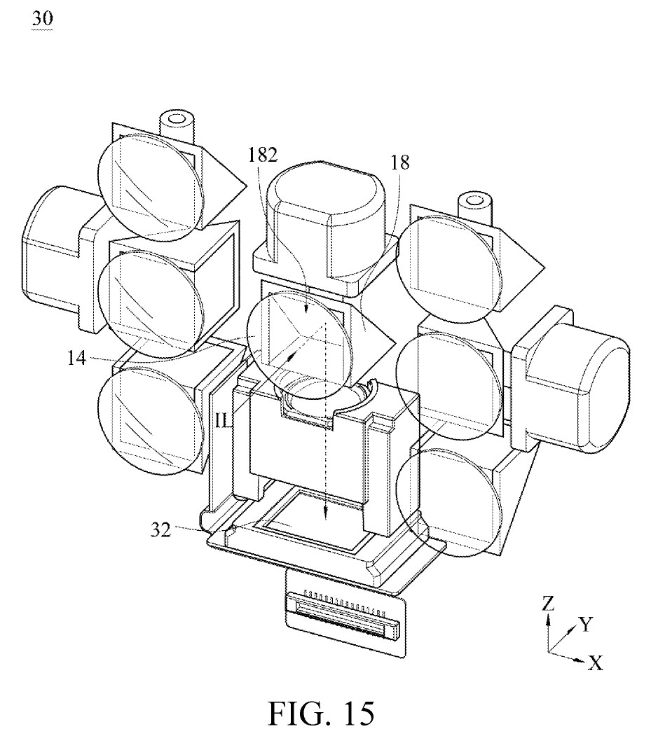

Referring to FIG. 14 together, FIG. 14 is a three-dimensional view of an image capture device according to yet another embodiment. In the embodiment in which a plurality of first lenses 12 and a plurality of fixed mirror assemblies 16 are provided, and one first lens 12 corresponds to one fixed mirror assembly 16 or one relay mirror assembly 22, where one relay mirror assembly 22 may be arranged between every two fixed mirror assemblies 16, the first lenses 12 may be located on a left side or a right side of the second lens 14. Alternatively, referring to FIG. 15, a plurality of first lenses 12 may be arranged on both sides of the second lens 14. This is not limited herein.

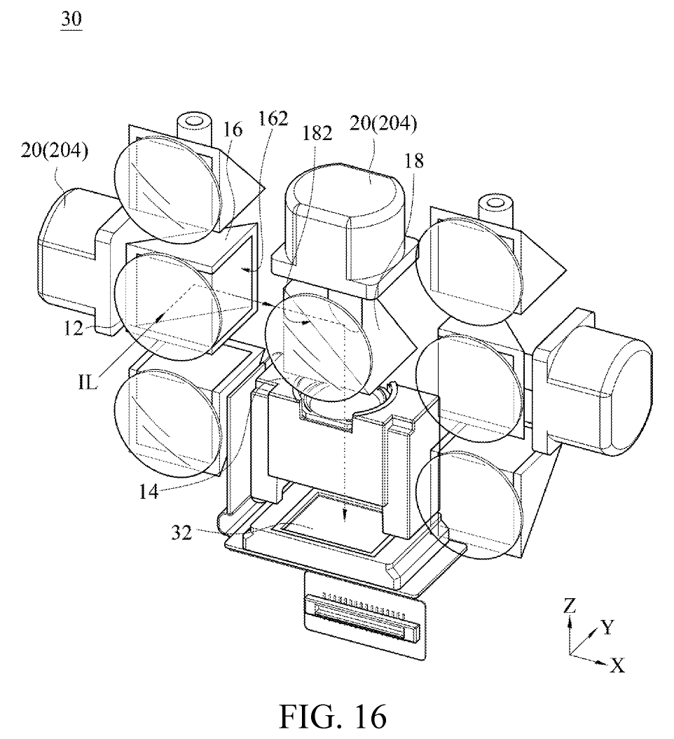

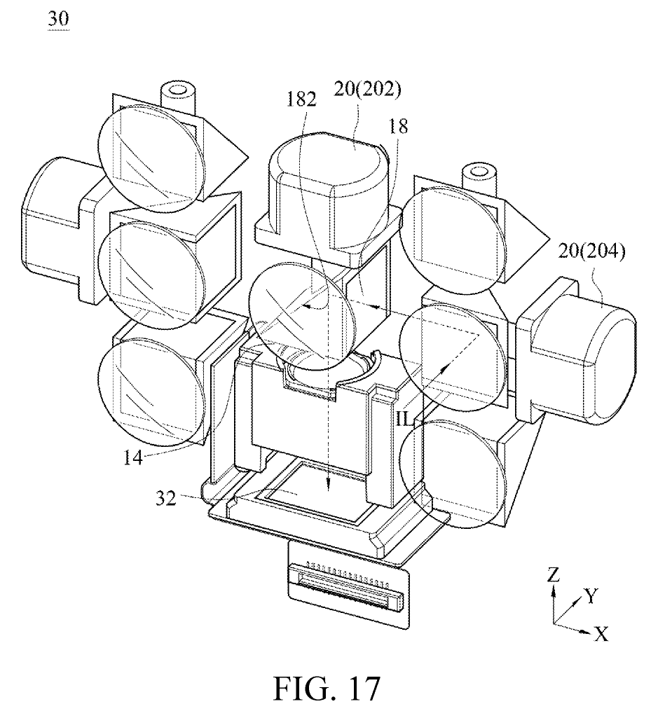

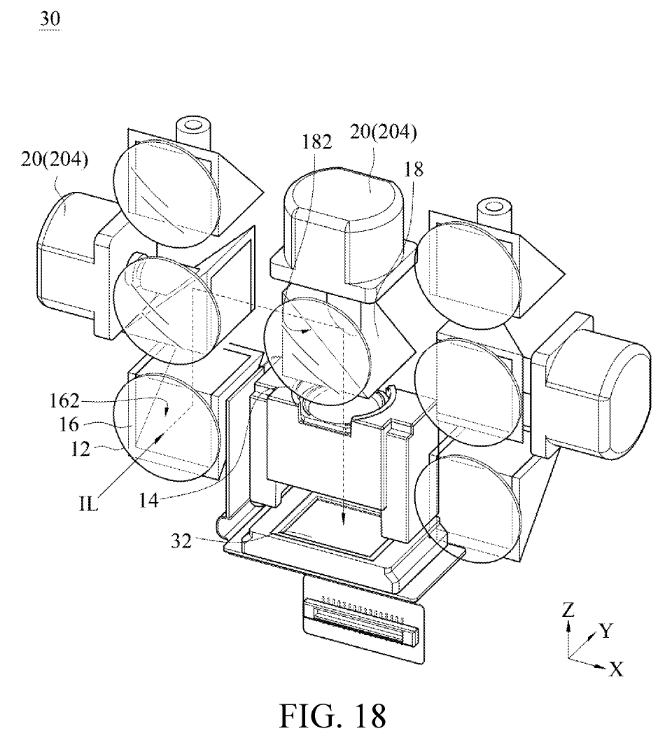

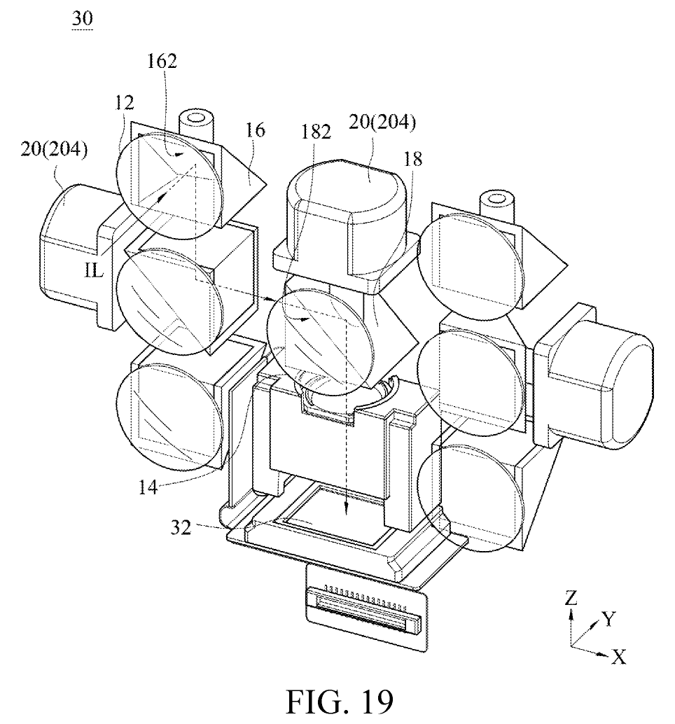

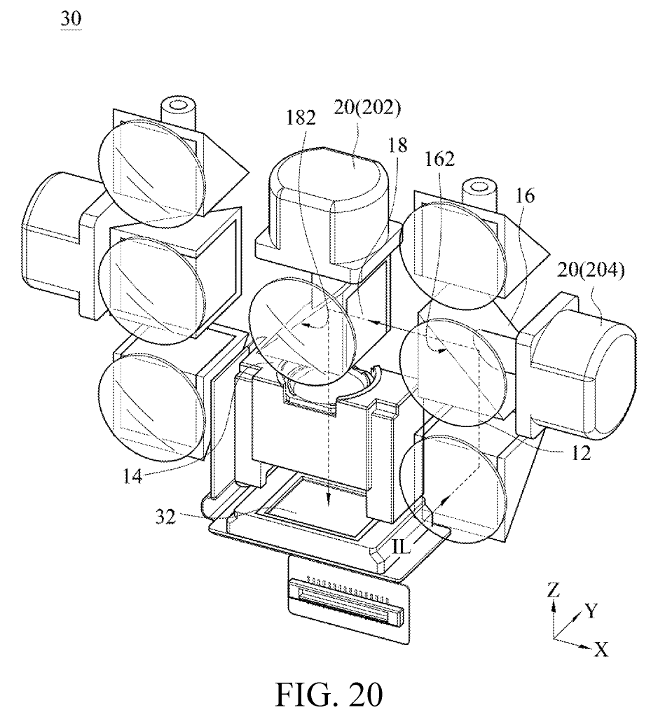

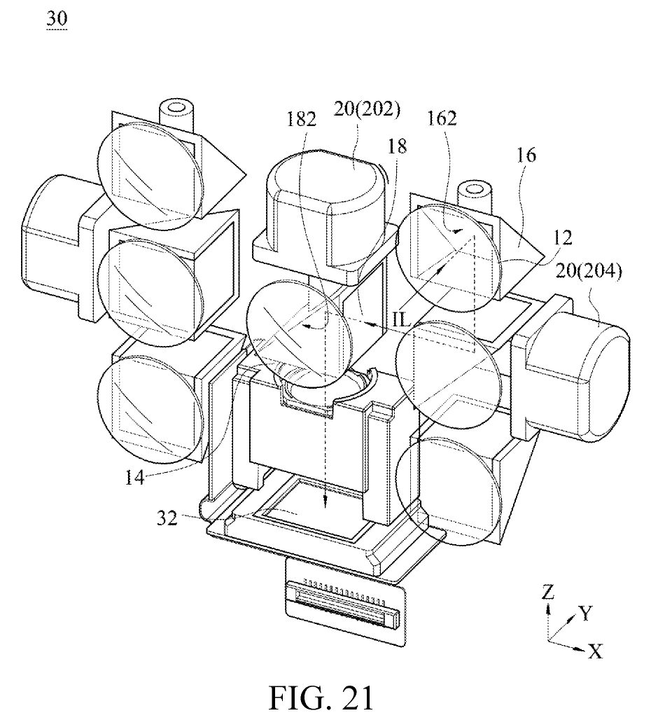

Referring to FIG. 16 to FIG. 21, FIG. 16 to FIG. 21 show optical path diagrams of entering the image capture device from each of the first lenses in the embodiment in FIG. 15. The first rotation module 202 and the second rotation module 204 may rotate in cooperation with each other, allowing an imaging light IL entering the image capture device 30 from each of the first lenses 12 to pass through the optical path switcher 10 to reach the photosensitive module 32.

Referring back to FIG. 4, in some embodiments, the first lens 12 has an incident optical axis OA1, the second lens 14 has an incident optical axis OA2, the incident optical axis OA1 and the incident optical axis OA2 are parallel to each other, and the imaging light IL entering the optical path switcher 10 may enter the first lens 12 and the second lens 14 along the incident optical axis OA1 and the incident optical axis OA2, respectively.

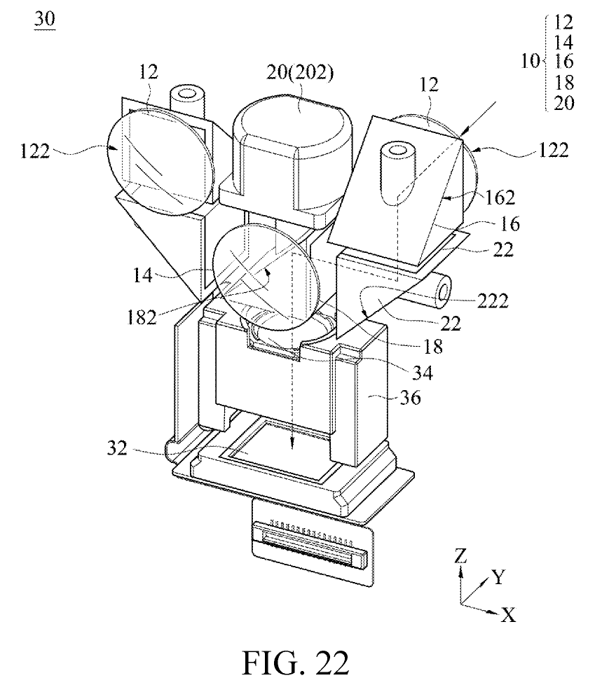

In the foregoing embodiment in which a plurality of first lenses 12 are provided, the first lenses 12 each may have an incident surface 122, and the incident surfaces 122 may face a same direction. Referring to FIG. 22, FIG. 22 is a three-dimensional view of an image capture device according to yet another embodiment. In some other embodiments, the incident surfaces 122 face different directions, so that imaging lights IL entering an optical path switcher 10 from different directions may be received, and in the embodiment in which the optical path switcher 10 is integrated into the image capture device 30, the imaging lights IL entering the optical path switcher 10 from all directions can all enter the same photosensitive module 32.

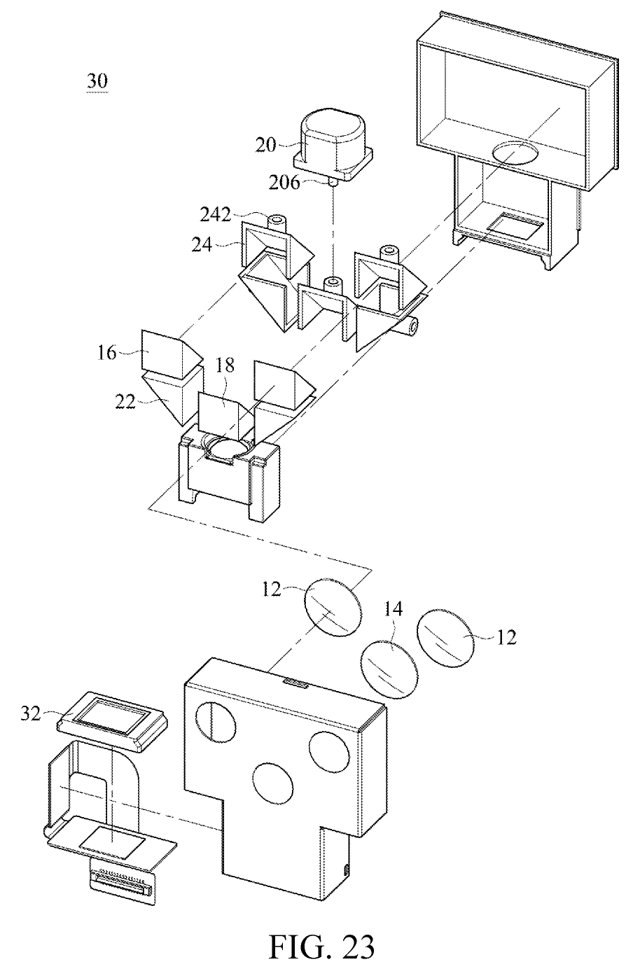

Referring to FIG. 23, FIG. 23 is an exploded view of elements of the image capture device according to the embodiment in FIG. 6. In some embodiments, the fixed mirror assembly 16, the movable mirror assembly 18, and the relay mirror assembly 22 each may be implemented through a triangular prism, and the first reflective surface 162, the second reflective surface 182, and the third reflective surface 222 may be the inclined surfaces of the triangular prism. In some other embodiments, the fixed mirror assembly 16 or the movable mirror assembly 18 may be formed by interconnected lenses, mirrors, and beam splitters. The first reflective surface 162, the second reflective surface 182, and the third reflective surface 222 are high-reflectivity mirrors, to reflect a light through total reflection or near total reflection.

In some embodiments, the fixed mirror assembly 16, the movable mirror assembly 18, and the relay mirror assembly 22 each include a mirror mount 24, and the first reflective surface 162, the second reflective surface 182, and the third reflective surface 222 are respectively fixed to the mirror mounts 24. In some embodiments, the mirror mounts 24 each include a fixed hole 242, the first rotation module 202 or the second rotation module 204 includes a pin 206, and the pin 206 is arranged in the fixed hole 242, so that when rotating, the first rotation module 202 or the second rotation module 204 drives the movable mirror assembly 18 or the relay mirror assembly 22 to rotate accordingly.

Referring to FIG. 4 together, in some embodiments, the image capture device 30 includes a focus lens 34 and an actuator 36, where the actuator 36 actuates the focus lens 34 to move between the movable mirror assembly 18 and the photosensitive module 32. The first lens 12 or the second lens 14 may be a fixed-focus lens, and the actuator 36 actuates the focus lens 34 to change a distance between the focus lens 34 and the photosensitive module 32 to achieve a zoom effect. The first lenses 12 and the second lens 14 have already enabled the image capture device 30 to have a plurality of focal lengths, and the first focal length or the second focal length combined with a focus range of the focus lens 34 allows the image capture device 30 to have an even wider focal length range.

In some embodiments, in addition to having different focal lengths, the first lens 12 or the second lens 14 may also be provided with different filters or have altered lens surface designs, enabling the image capture device 30 to have different filter effects to meet more photography requirements of users.

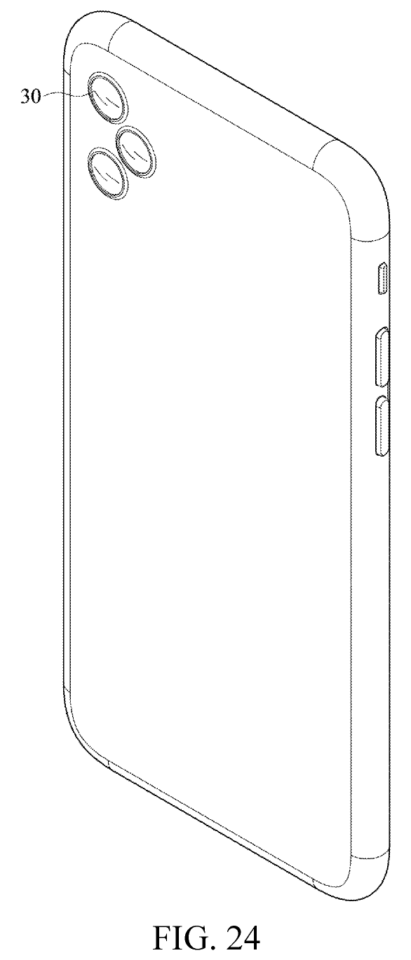

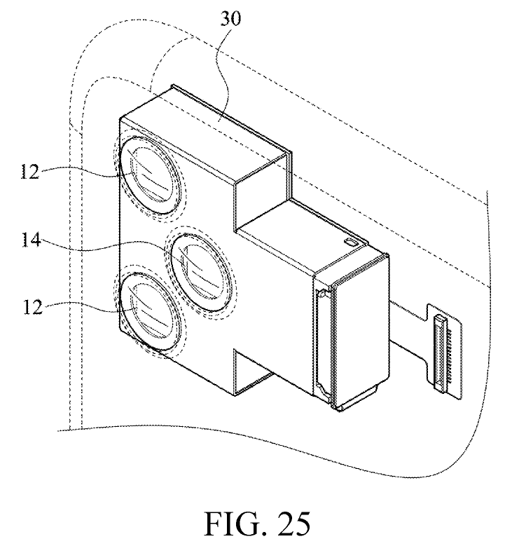

Referring to FIG. 24 and FIG. 25, FIG. 24 is a schematic diagram of an electronic device according to an embodiment, and FIG. 25 is a perspective view of the embodiment in FIG. 24. In some embodiments, an image capture device 30 may be integrated into the electronic device as a photography device of the electronic device, enabling the electronic device to satisfy various photography requirements of users. In some embodiments, the electronic device may be equipped with a front lens or a rear lens, to facilitate photographing of objects in different directions by users using the electronic device. In the embodiment in which the incident surfaces 122 of the first lenses 12 face different directions, one of the first lenses 12 is used as the front lens in the electronic device, and another first lens 12 and a second lens 14 are used as the rear lenses in the electronic device. Through the optical path switcher 10, the imaging light IL entering each of the first lenses 12 and the second lens 14 can reach a same photosensitive element. Therefore, when the image capture device 30 needs only one photosensitive element, the space to be reserved for the image capture device 30 in the electronic device can be greatly reduced, to reduce the size of the electronic device. The electronic device may be a mobile phone, a tablet computer, or the like.

In some embodiments, the first lens and the second lens may be implemented by using lens types such as a spherical lens, an aspherical lens, a Poisson aspherical lens, a mirror lens, a lens element, a variable focus lens, and a varifocal lens.

In some embodiments, the photosensitive module 32 may be a photosensitive device, such as a complementary metal-oxide-semiconductor (CMOS) photosensor, a charge-coupled device (CCD) photosensor, or a back side illuminated (BSI) photosensor, which converts photons into electronic signals.

In some embodiments, the rotation module 20 may be implemented by a stepper motor, a voice coil motor (VCM), a piezo electric motor, a shape memory alloy (SMA) motor, or a micro-electro mechanical system (MEMS).

In conclusion, the optical path switcher 10 may allow lights entering the image capture device 30 from different lenses to enter the same photosensitive module 32. If the electronic device needs to be equipped with a plurality of lenses, a quantity of photosensitive modules 32 can be reduced, and therefore the optical path switcher 10 can significantly reduce the size of the electronic device.

Certainly, the present invention may further have a plurality of other embodiments. A person skilled in the art may make various corresponding changes and variations according to the present invention without departing from the spirit and essence of the present invention. However, such corresponding changes and variations shall fall within the protection scope of the claims of the present invention.

What is claimed is:

1. An optical path switcher, comprising:
a first lens, having a first focal length;
a second lens, adjacent to the first lens, wherein the second lens has a second focal length, and the second focal length is different from the first focal length;
a fixed mirror assembly, located downstream of the first lens in an optical path corresponding to the first lens, wherein the fixed mirror assembly comprises a first reflective surface;
a movable mirror assembly, located downstream of the second lens in an optical path corresponding to the second lens or downstream of the first reflective surface in an optical path corresponding to the first reflective surface, wherein the movable mirror assembly comprises a second reflective surface; and
a rotation module, comprising a first rotation module connected to the movable mirror assembly, wherein the first rotation module drives the movable mirror assembly to rotate to cause the second reflective surface to be located downstream of the second lens in the optical path corresponding to the second lens or downstream of the first reflective surface in the optical path corresponding to the first reflective surface.

2. The optical path switcher according to claim 1, wherein when the second reflective surface faces the second lens, an imaging light passes through the second lens and is reflected by the second reflective surface.

3. The optical path switcher according to claim 1, wherein when the second reflective surface faces the first reflective surface, an imaging light passes through the first lens and is reflected sequentially by the first reflective surface and the second reflective surface.

4. The optical path switcher according to claim 3, comprising a relay mirror assembly, wherein the relay mirror assembly comprises a third reflective surface, and the third reflective surface is located between the first reflective surface and the movable mirror assembly, to reflect the imaging light reflected by the first reflective surface to the second reflective surface.

5. The optical path switcher according to claim 4, wherein a plurality of first lenses are provided, a plurality of fixed mirror assemblies are provided, the rotation module comprises a second rotation module connected to the relay mirror assembly, and the second rotation module drives the relay mirror assembly to rotate to cause the third reflective surface to be located downstream of the first reflective surface of one of the fixed mirror assemblies and upstream of the movable mirror assembly in an optical path corresponding to the fixed mirror assembly and the movable mirror assembly.

6. The optical path switcher according to claim 4, wherein the movable mirror assembly comprises a light shielding surface located on a back surface of the second reflective surface, and the light shielding surface does not allow a light to penetrate.

7. The optical path switcher according to claim 1, wherein the first lens and the second lens each have an incident optical axis, the incident optical axes are parallel to each other, and an imaging light enters the first lens and the second lens along the incident optical axes.

8. The optical path switcher according to claim 1, wherein a plurality of first lenses are provided, each of the first lenses has an incident surface, and the incident surfaces face different directions.

9. An image capture device, comprising:
an optical path switcher, comprising:
a first lens, having a first focal length;
a second lens, adjacent to the first lens, wherein the second lens has a second focal length, and the second focal length is different from the first focal length;
a fixed mirror assembly, located downstream of the first lens in an optical path corresponding to the first lens, wherein the fixed mirror assembly comprises a first reflective surface;
a movable mirror assembly, located downstream of the second lens in an optical path corresponding to the second lens or downstream of the first reflective surface in an optical path corresponding to the first reflective surface, wherein the movable mirror assembly comprises a second reflective surface; and
a rotation module, comprising a first rotation module connected to the movable mirror assembly, wherein the first rotation module drives the movable mirror assembly to rotate to cause the second reflective surface to be located downstream of the second lens in the optical path corresponding to the second lens or downstream of the first reflective surface in the optical path corresponding to the first reflective surface; and
a photosensitive module, located downstream of the second reflective surface of the movable mirror assembly in an optical path corresponding to the movable mirror assembly.

10. The image capture device according to claim 9, comprising a focus lens and an actuator, wherein the actuator actuates the focus lens to move between the movable mirror assembly and the photosensitive module.
